(19) United States
(12) Patent Application Publication
(10) Pub. No.: US 2012/0221387 A1
(43) Pub. Date: Aug. 30, 2012

(54) SYSTEM FOR PROVIDING INCENTIVES FOR REFERRING ADVERTISEMENTS AND DEALS

(75) Inventors: Kun Liu, Sunnyvale, CA (US); Abraham Bagherjeiran, Sunnyvale, CA (US); Vijay K. Narayanan, Mountain View, CA (US); Rajen Subba, Mountain View, CA (US); Lei Tang, Santa Clara, CA (US)

(73) Assignee: Yahoo! Inc., Sunnyvale, CA (US)

(21) Appl. No.: 13/034,342

(22) Filed: Feb. 24, 2011

(51) Int. Cl. G06Q 30/00

(52) U.S. Cl. 705/14.16

(57) ABSTRACT

A system for incentivizing sharing advertisements (“ads”) and associated deals with others includes a processor programmed to transmit to a user, for display in an application window of a communication device of a user, an advertisement and an associated deal with an economic incentive for sharing the advertisement with first persons in a social network of the user. The system tracks and stores referral activity by the first persons in the social network of the user in relation to the advertisement, the referral activity including the first persons sharing the advertisement with second persons. The system tracks and stores conversion activity such as purchasing by the first persons in the social network of the user in relation to the deal and purchasing by second persons referred by the first persons. The system delivers the economic incentive to the user for sharing with the first persons; for the first and second persons who share the advertisement; and/or for the first and second persons who convert the deal.

### BACKGROUND

1. Technical Field

The disclosed embodiments relate to systems and methods for advertisement deal sharing, and more particularly for incentivizing referring advertisement deals to connected persons or friends within a social network.

2. Related Art

Internet advertising is a multi-billion dollar industry and is growing at double digit rates in recent years. It is also the major revenue source for internet companies such as Yahoo!® that provide advertising networks that connect advertisers, publishers, and Internet users. As an intermediary, these companies are also referred to as advertiser brokers. New and creative ways to attract attention of users to advertisements (“ads”) or to the sponsors of those advertisements help to grow the effectiveness of online advertising, and thus increases the growth of sponsored and organic advertising. Publishers partner with advertisers, or allow advertisements to be delivered to their web pages, to help pay for the published content, or for other marketing reasons.

Social networking has also blossomed and provides a unique, relatively new source of advertising. Social networking sites can obtain information about its users that is more plentiful and easier to track and put to use compared to times before social media. This information can be leveraged to better target advertising to social media users that they are more likely to be interested in, making the advertising experience more enjoyable for the users and more profitable for the advertisers. As sales professionals know, however, direct referrals of a product or service from people you know or with whom you are associated often provides a higher likelihood that users will purchase.

### BRIEF DESCRIPTION OF THE DRAWINGS

The system may be better understood with reference to the following drawings and description. The components in the figures are not necessarily to scale, emphasis instead being placed upon illustrating principles. In the figures, like referenced numerals may refer to like parts throughout the different figures unless otherwise specified.

FIG. 1 is a diagram of an exemplary system for incentivizing referrals of advertisements (“ads”) and associated deals from social network users to connected persons in their respective social networks.

FIG. 2 is a screen shot of a browser displaying an advertisement and associated deal along with an invitation to a user to refer the ad to others for an additional percentage off the ad deal, and a period of time left to take advantage of (or convert) the ad deal.

FIG. 3 is a screen shot displaying the advertisement, the deal, and the invitation of FIG. 2 in which the user is in the process of purchasing the product advertised in the ad deal, and thus converting the ad deal.

FIG. 4 is a screen shot displaying a confirmation to the user, thanking the user for purchasing the product in the ad deal of FIG. 2, an amount saved, and more details about the invitation to refer the ad deal to others.

FIG. 5 is a screen shot of a browser displaying a list of connected persons or friends in a social network of the user to whom the user can refer the ad deal in response to the user accepting the invitation in FIGS. 2-4 to refer or share the ad deal to others.

FIG. 6 is a screen shot of a browser displaying an information screen summarizing the opportunities and limitations with regards to the invitation in FIG. 4 to refer the ad deal to others.

FIG. 7 is a screen shot of a browser displaying a status page detailing information about the period of time left to purchase the ad deal of FIG. 2 and statistical-type information related to the extent to which users have shared the ad, users have converted the deal associated with the ad, and users have saved based on the conversion and sharing.

FIG. 8 is a flow chart of a method for incentivizing sharing advertisements (“ads”) and converting related deals by providing economic incentives to users for downstream users that share the ad and/or that convert the deal.

FIG. 9 is a flow chart of a method for incentivizing sharing of advertisements (“ads”) from social network users to connected persons in their respective social networks.

FIG. 10 is a flow chart of a method for incentivizing sharing of ads and associated deals from social network users to connected persons in their respective social networks.

FIG. 11 illustrates a general computer system, which may represent any of the computing devices referenced herein.

### DETAILED DESCRIPTION

By way of introduction, the disclosed embodiments relate to a system for incentivizing social network users to share advertisements (“ads”) and associated deals with connected persons or friends in their respective social networks. The system may transmit an ad with an economic incentive to an application window of a user for sharing the ad with first persons in a social network of the user. The system may track and store referral activity by the first persons in the social network of the user in relation to the advertisement, the referral activity including the first persons sharing the advertisement with second persons. The system may then deliver the economic incentive to the user for sharing with the first persons and for the first and second persons who share the advertisement.

The system may further incentivize sharing the ads with the intent of getting downstream connected persons in social networks of the users to convert a deal associated with the ad. “Downstream” refers to referrals that refer others that refer others, etc., which creates a sequential chain of referrals. To convert a deal or the term “conversion” includes but is not limited to the purchase of an advertised product, signing up for an advertised service, joining a group related to an advertiser of the advertisement, or some other final action that can be taken by a user that links to a landing or home page of an advertiser where a deal can be accepted. The system may transmit to the application windows of a user: an ad, an associated deal, and an economic incentive for referring the advertisement to first persons in a social network of the user. The system may track and store conversion activity by the first persons in the social network of the user in relation to the deal and by second persons referred by the first persons in relation to the deal. The system may then deliver the economic incentive to the user for the first second persons who converted the deal. The system may limit the user to no more than a predetermined amount of accruable economic incentive based on downstream referrals. Limits may also be placed on the circumstances of the sharing and referring with regards to how many downstream referred persons from which a user can receive economic incentive based on the user's initial sharing of the ad with the first persons.

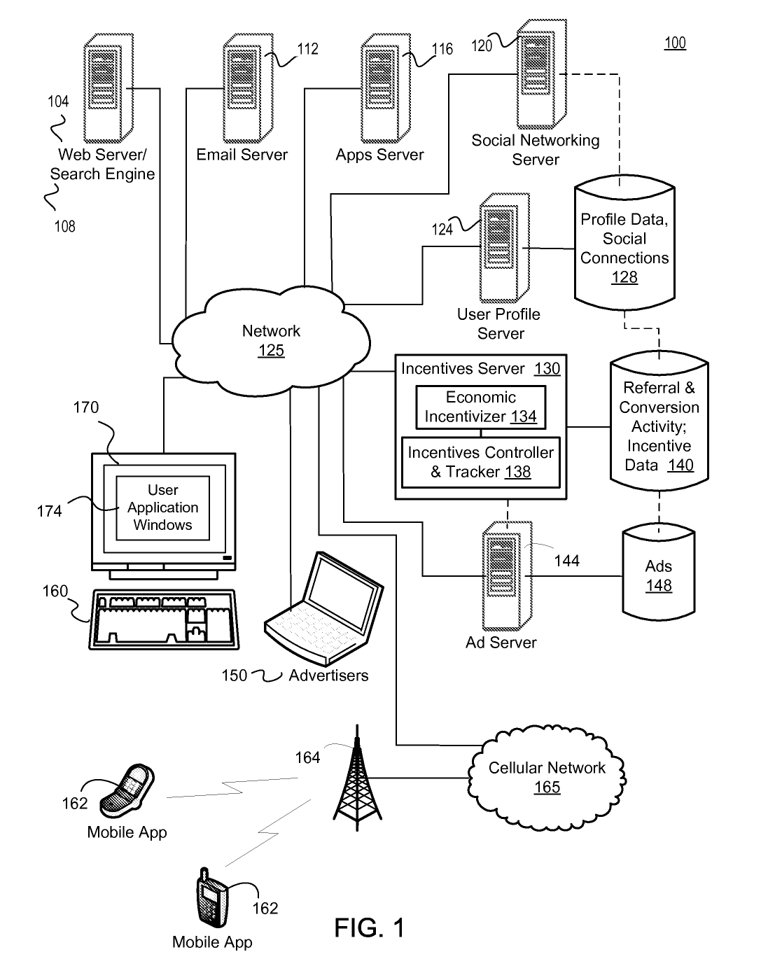

In FIG. 1, an exemplary system 100 for incentivizing referrals of ads and associated deals from social network users to connected persons in their respective social networks may include a number of servers and computing devices. The system 100 may include a web server 104 which may also include or be integrated with a search engine 108, an email server 112, an applications server 116, a social networking server 120, and a user profile server 124. All of these servers may intercommunicate or be coupled together through a network 125. Herein, the phrase “coupled with” is defined to mean directly connected to or indirectly connected through one or more intermediate components, including a network. The user profile server 124 may include or be coupled with a profile data and social connections database 128 stored in storage memory. The database 128 may be shared with or otherwise coupled with the social networking server 120, which may generate and track the social connections as users create and update their social connections in a social network. A user's profile may include information provided by the user including their likes and dislikes, interests, work history, personal history, and personal connections. The user's profile may also be built from online browsing, searching, and purchasing history of the user.

The system 100 may also include an incentives server 130 including an economic incentivizer 134 and an incentives controller and tracker 138. The incentives server 130 may include or be coupled with a referral and conversion activity database 140 that may also include incentive data in addition to the referral (sharing) and conversion activity of users in the social network. The system 100 may also include an ad server 144 that may be integrated or be coupled with the incentives server 130. The ad server 144 may include or be coupled with an ads database 148 stored in storage memory of the ad server 144. Accordingly, the dashed line indicates that the ads database 148 and the referral and conversion activity database 140 may be combined in one database or may be coupled together, including being shared across the network 125.

The system 100 may also include a plurality of advertiser communication devices 150 through which the advertisers may communicate over—and upload advertisements to—the network 125 to be stored and served from the ad server 144. The system 100 may also include a plurality of user communication devices 160 that may include stationary devices 160 as well as mobile communication devices 162 such as cell phones, tablet and laptop computers, and smart phones, etc. The mobile communication devices 162 may communicate with each other and with the network 125 through a base station 164 such as a cellular tower, and through a cellular network 165 to include various cellular switches and networking devices (not shown). The cellular network 165 may be coupled with the network 125, which may be a wired and/or a wireless network that provides internet connectivity to the mobile devices 162.

The user communication devices 160, including the mobile devices 164, may include a screen or display 170 in which is displayed an application window 174 which may include a browser or other program application. The ad server 144 in conjunction with the economic incentivizer 134 may serve advertisements (“ads”) to application windows 174 or browsers 174 of the user communication devices 160 and 162 and include an incentive for sharing the ad to first connected persons in the social network of users. The ads from the advertiser 150, which may be served from the ads database 148 of the ad server 144, may be served to users in response to a search query submitted to the search engine 108, to a web page the user browses to that is delivered by the web server 104, or served to an email program of the email server 112 or to an application of the applications server 116 that the user accesses over the network 125.

The economic incentive for the user converting the deal may include a first percentage off the deal. The incentive for sharing may include points or credits that may go towards purchases of goods or services from the advertiser of the ad or from a service provider that is in control of the incentives server 130 and the ad server 144. The points or credits may be viewed as virtual currency that may be redeemed in any manner in the future. The economic incentives may include incentives provided for second connected persons with whom the first connected persons also share the ad. The points or credits provided to a user for sharing with the first connected persons may be greater than the points or credits provided to the user for the first connected persons that share with the second connected persons. Diminishing incentives may be provided to the user for further downstream sharing by the second and subsequent connected persons.

Alternatively or in addition, the ad may be served with an associated deal with additional or different incentives for when the user converts the deal and for when the first and second connected persons convert the deal. The economic incentive for the user converting the deal may include a first percentage off the deal. The economic incentives may further include a second, additional percentage off for each first person that converts the deal and a third, additional percentage off the deal for each second person that convert the deal. The second, additional percentage off may be more than the third, additional percentage off. Diminishing incentives may be provided for third connected persons and those to whom the deal is referred further downstream from the second connected persons. In addition or as an alternative to percentages off, the economic incentives for referred, connected persons that convert the deal may include credits or points additional to those awarded for sharing.

The first, second, and subsequent connected persons in the social network may also be generally referred to as users and be offered economic incentives for their sharing the ad and/or referring the deal associated with the ad as previously discussed, thus creating a viral effect and motivation for users to continue sharing the deal throughout their respective social networks. The incentives controller and tracker 138 may track referral and conversion activity by the users of the social network with respect to the advertisements served by the ad server 144. This data may be stored in the referral and conversion activity database 140. The ads and associated deals may be sent to users for their consideration through email or through a social networking site or application.

To help curb fraud or other abuses of the system 100, the system 100 may, through the incentives server 130, limit the extent that users can accrue economic incentives for sharing ads and referring deals associated with the ads. For instance, the system 100 may limit the number of first persons with whom the user is allowed to share any given ad. The system 100 may also limit a total amount of economic incentive accruable to a user for sharing the deal. Users that have produced significant revenue in the past through sharing and referring may have a greater cut off limitation of economic incentive accruable to them. Furthermore, the amount of economic incentive to the user for downstream sharing and referrals may be increasingly diminished as the connected persons become further removed down a chain of referrals of connected persons.

To help explain an example of how the incentives could work, suppose a user gets x% off of a deal when converting the deal. Suppose further that the user gets y additional points when the referred friend converts and z additional points when the referred friend does not convert, where z is less than y. Further assume that users can earn points within two hops from themselves. In one example, assume user A is shown the ad but does not convert yet shares with user B. User B does not convert and then shares with user C. User C converts and shares with user D. User D does not convert. The economic incentives provided to these users would include: user A gets y+z points; user B gets y+z points; and user C gets the original discount of x % and z points. Suppose, however, if there were a user in the referral chain between users A and B, user A would not get the y points because it would push the conversion of user C to three hops. This is merely an example and there may be dozens or hundreds of possible scenarios.

For instance, an alternative to the original set of incentives is to provide an incentive of an immediate, larger discount than x % based on an expected number of downstream conversions or sharing in the social network. As an example, instead of x % and z points for sharing, C could choose an immediate discount of (x+u) % on the deal after sharing. The expected incremental discount, u, may be determined by the advertiser or by the service provider of the incentives server 130 based on an expected value of the downstream conversion. This value may become more predictable over time, especially with regards to certain social sub-networks as various users develop patterns of sharing.

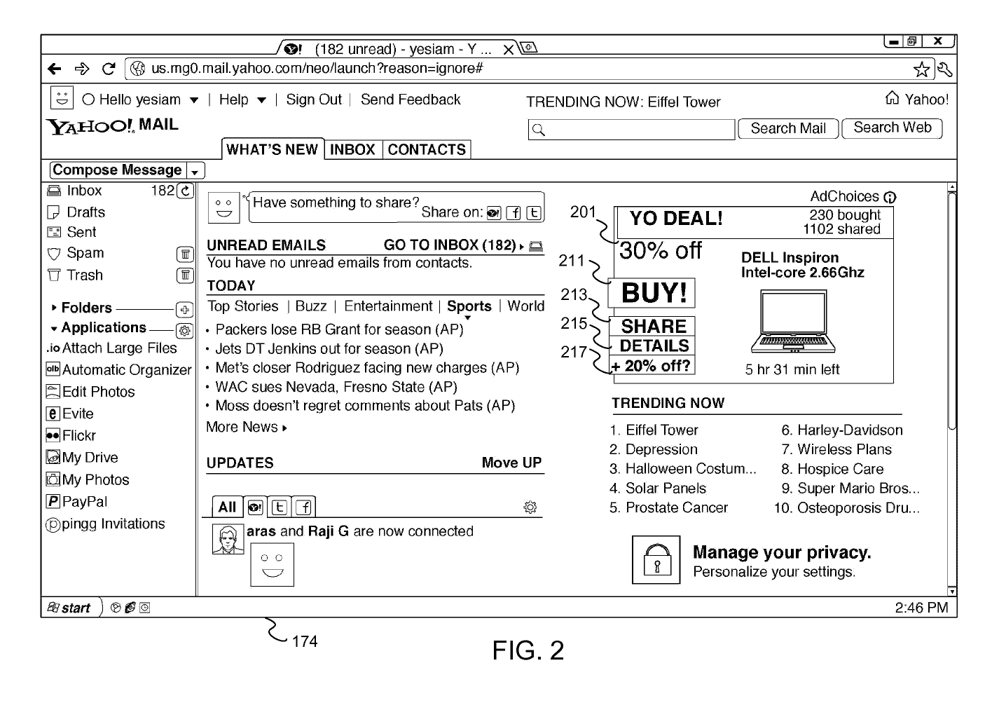

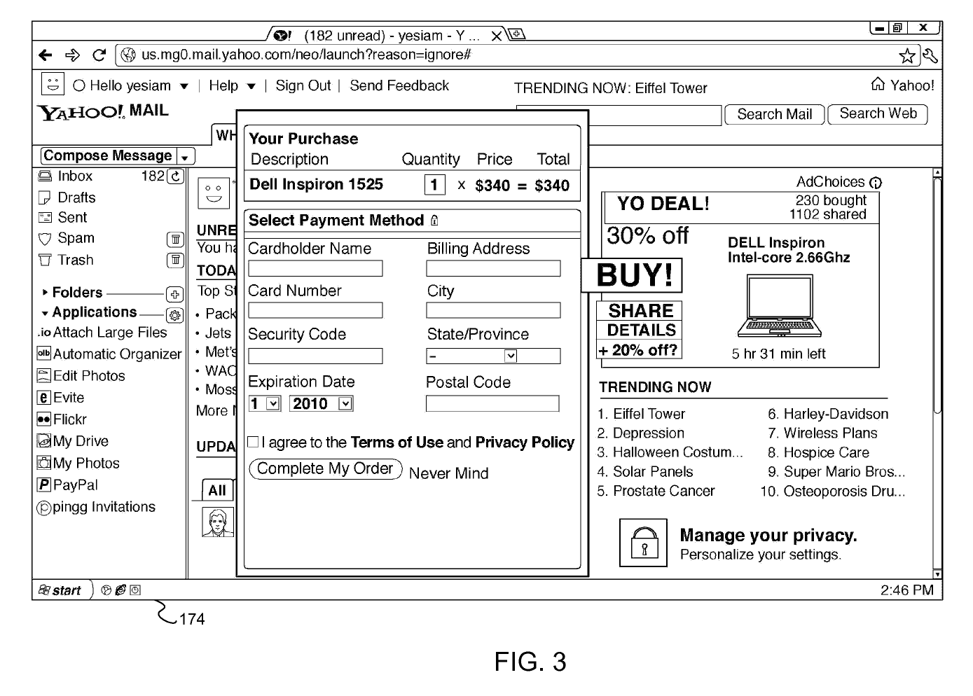

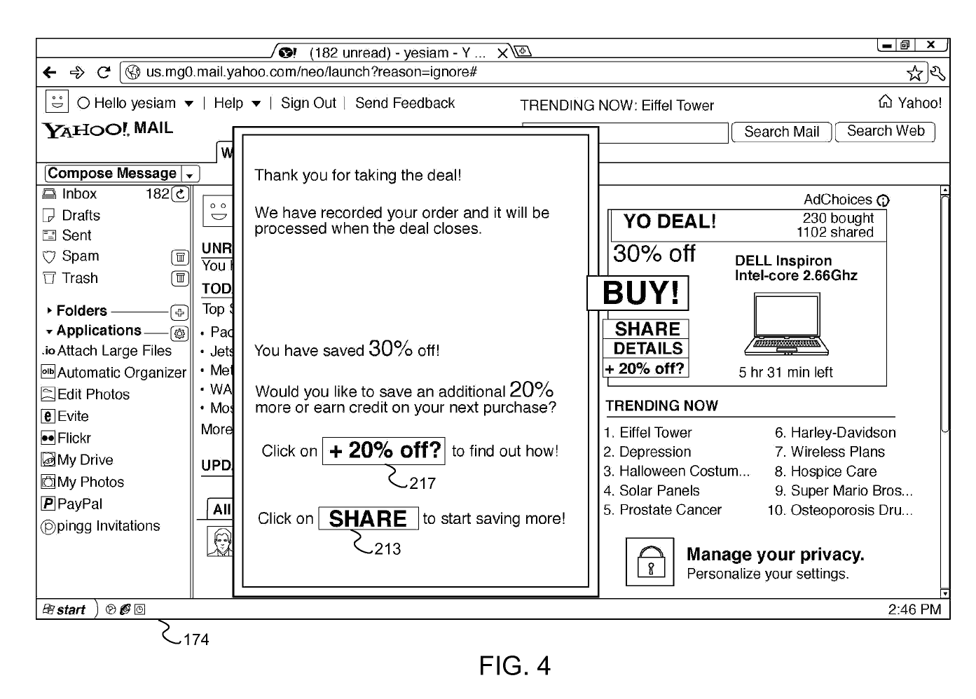

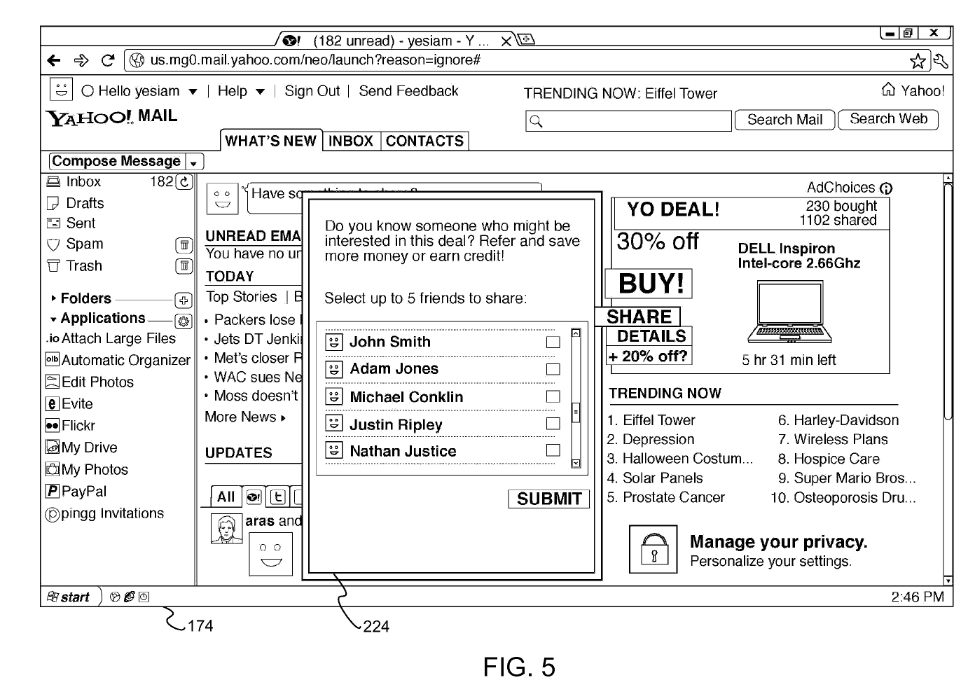

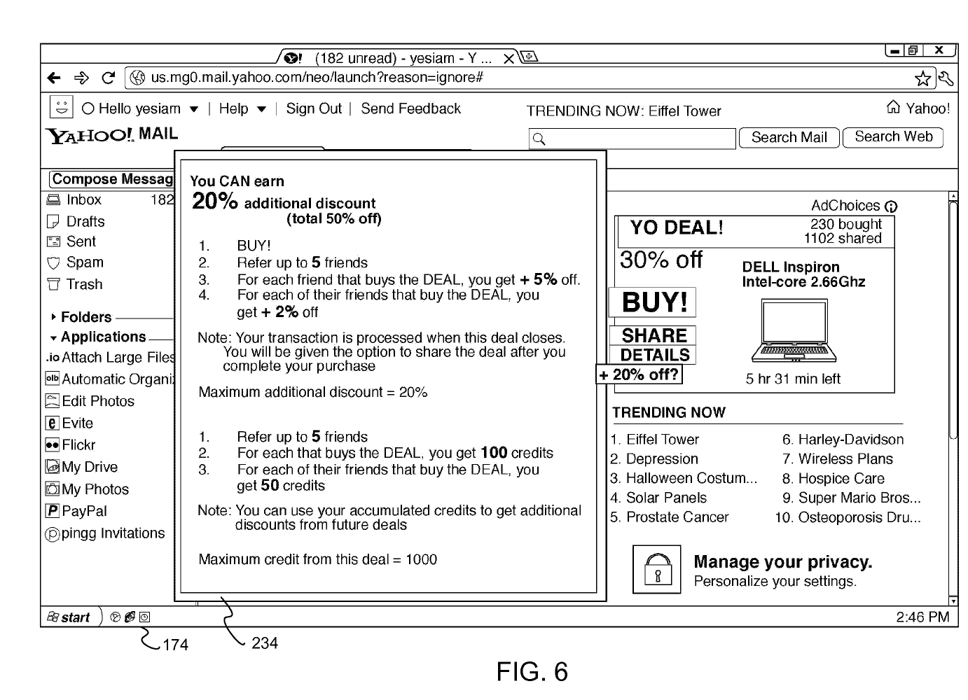

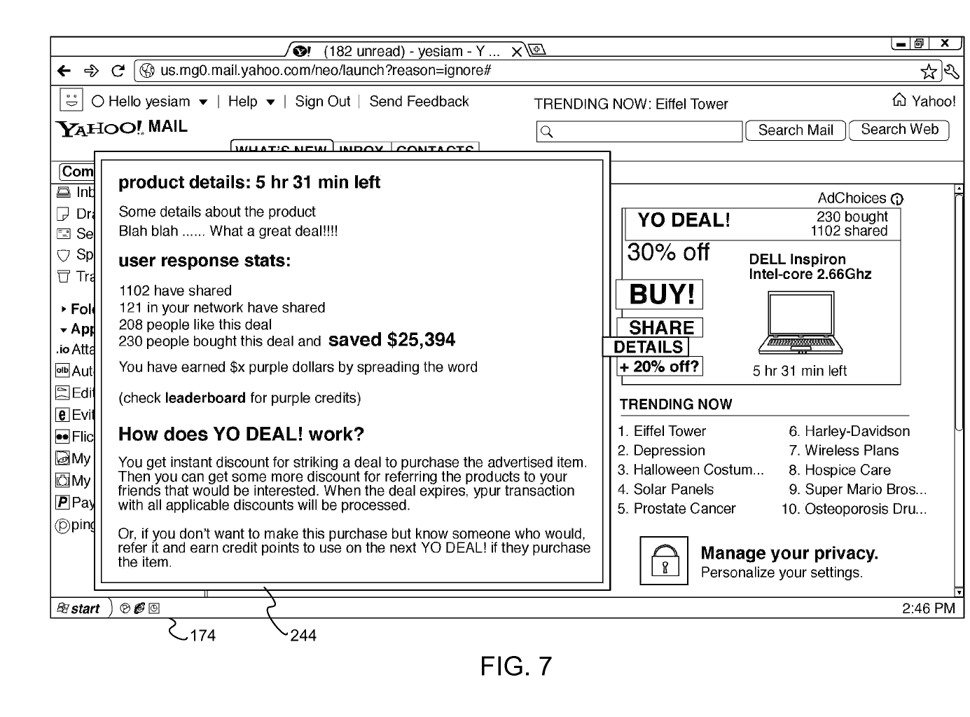

FIG. 2 is a screen shot of a browser displaying an advertisement and associated deal 201 along with an invitation to a user to refer the ad to others for an additional percentage off the ad deal, and a period of time left to take advantage of (or convert) the ad deal. Note that there are a number of indicia provided with the advertisement for easy selection by a user to take action with reference to the deal or to obtain more information with reference to the incentives. For instance a first indicia 211 may be selected to purchase (or otherwise convert) the deal 201, which will be discussed in more detail with reference to FIGS. 3 and 4. A second indicia 213 may be selected to share the deal with others in a social network of the user, which will be discussed in more detail with reference to FIG. 5. A third indicia 215 may be selected to obtain a status page showing progress of sharing and deal conversion within the social network, which will be discussed in more detail with reference to FIG. 7. And, a fourth indicia 217 may be selected to learn how to obtain up to an additional certain percentage off the deal when the user purchases, or how to obtain additional points or credits for sharing the deal, which will be discussed in more detail with reference to FIG. 6.

FIG. 3 is a screen shot displaying the advertisement, the deal, and the invitation of FIG. 2 in which the user is in the process of purchasing the product advertised in the ad deal, and thus converting the ad deal. Note that the user automatically receives a 30% (or other percentage) discount for purchasing the deal, but as will be discussed later, the user may earn an additional percentage off before the end of the deal period when referred persons in the social network of the user also convert. For instance, in FIG. 4, the system 100 displays a confirmation to the user, thanking the user for purchasing the product in the ad deal of FIG. 2, an amount saved, and more details about the invitation to refer the ad deal to others. This confirmation screen reminds the user that the user's order will be processed when the deal closes, and then invites the user to learn more about how the user can save up to an additional 20% off the purchase of the deal by displaying a link to the fourth indicia 217. The invitation to learn more may link to the second indicia 213 to go directly to share the advertisement and associated deal with connected persons (or friends) of the social network of the user.

In FIG. 5, when the second indicia 213 is selected by the user, a second window 224 can pop up, including another browser window or application window 224, through which the user may select friends or connected persons of a social network of the user. In the alternative, the selection options may be delivered to the same application window 174 in which the deal is advertised to the user, which may therefore also be referred to as the second window 224 for purposes of delivering a list of connected persons to the user from which to select. The social networking server 120 may respond to the selection of the second indicia 213 and deliver a list of connected persons associated with the user to the window 224. In the alternative, the user can link to a social networking website from the application window 174 and select connected persons with whom to share the advertisement and deal, which can then be communicated back to the incentives server 130 for tracking. The system 100 may limit the number of connected persons or friends with whom a given user can share an advertisement and associated deal.

Selection of the fourth indicia 217 may link to a third screen 234 such as that shown in FIG. 6, which displays information summarizing the opportunities and limitations with regards to the invitation in FIG. 4 to refer the ad deal to others, which may result in up to an additional 20% off. The amount of the discounts or point or credits awarded as disclosed herein are merely exemplary and are not to be considered limiting of the scope of the present disclosure. The third screen 234 may also be embedded in the original application window 174. One example of the requirements to secure the additional 20% off may include, but are not limited to: (1) buy the ad deal; (2) share the ad deal with up to five others; (3) for each friend that buys (or converts) the ad deal you will get 5% of and (4) for each of the your friends' friends that buys (or converts) the ad deal you will get 2% off. The third screen 234 may also inform the user that the maximum accumulation of discount is a certain percentage off, in this case 20% and that the user will be given the chance to share the ad and the ad deal with their connected persons after completing the purchase.

The third screen 234 displayed in FIG. 6 may also explain the option to earn points or credits for just sharing the deal. The requirements for earning points or credits may include but are not limited to: (1) refer or share the ad and the ad deal with up to five friends; (2) for each friend that buys (or converts) the deal you will earn 100 credits; and (3) for each of the friends' friends that convert the deal you will earn 50 credits. Alternatively, the user may be provided credits for merely sharing and credits for friends that merely share the ad and the ad deal with further downstream friends, but those credits may be diminished compared with those awarded when friends convert. The third screen 234 may also indicate a maximum number of credits available to earn from sharing the ad and the deal with others.

FIG. 7 shows a status page 244 detailing information about the period of time left to purchase the ad deal and statistical-type information related to the extent to which users have shared the advertisement (“ad”) and to which users have converted the deal associated with the ad. Accordingly, the status page 244 may include but not be limited to: a number of the plurality of users that have shared or converted the advertisement and deal (such as 1,000 or 2,000 people or some other number); an amount of credits or points accrued or accumulated by the user for sharing the advertisement and for the first and second users that convert the deal; an amount of saved currency in converting the deal by the user based on the first, second, and third additional percentages off; an amount of currency saved by users in the social network that also converted the deal based on the sharing of the advertisement; and a leader board of users ranked by amount of currency saved to the users with whom the advertisement and deal were shared by ranked users. Alternatively, instead of listing statistics according to saved currency, the system 100 may do so according to percentage of discounts and the like. The economic incentive may include an amount of currency, a number of credits, and/or an additional percentage off conversion of the deal.

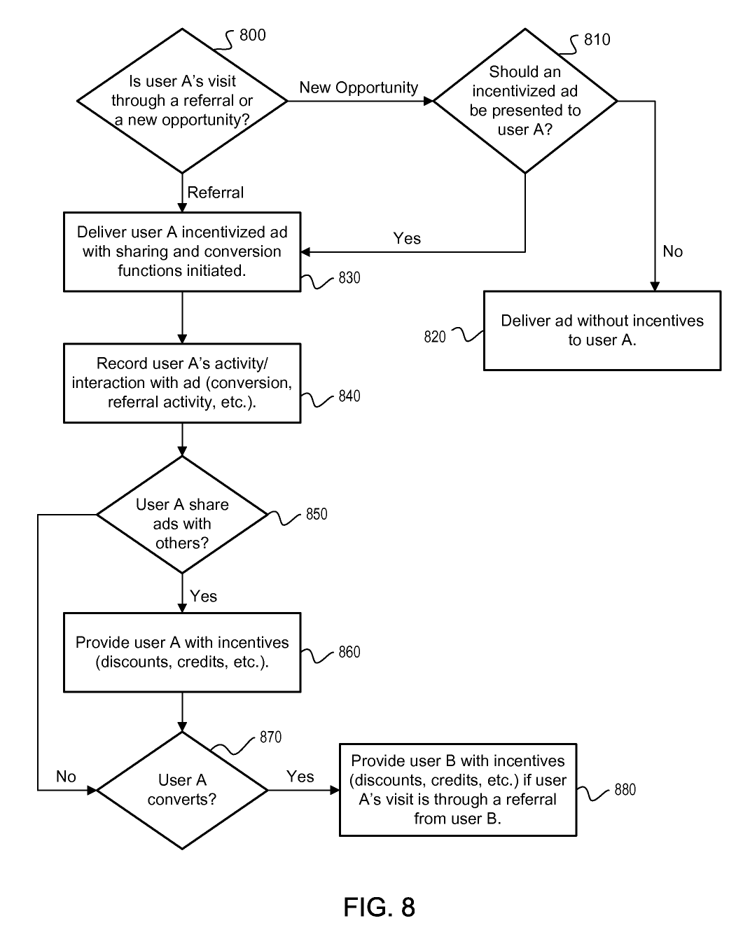

FIG. 8 is a flow chart of a method for incentivizing sharing advertisements (“ads”) and converting related deals by providing economic incentives to users for downstream users that share the ad and/or that convert the deal. At block 800, the system 100 determines whether user A's visit to a landing page of an advertiser is through a referral or a new opportunity. If through a new opportunity, the system 100, at block 810, determines whether an incentivized ad should be presented to user A by determining whether user A is appropriate for an incentivized ad based on one or more of the following criteria: (1) demographic or geographic information of user A, e.g., such that an advertiser may target with the ad; (2) user A's interests which are derived from past online activities, e.g., page views, ad clicks, search engine searches; (3) based on how socially active is user A; and (4) if user A is a spammer or a robot. With regards to criteria (3), if user A never shares any ads or deals even when given incentives, it is probably not worth showing user A incentivized ads. With regards to criteria (4), the system may not deliver an incentivized ad to a spammer or robot. The system may also take into account the opportunity cost of replacing some other regular ad when determining whether to show the incentivized ad such as by considering the expected cost of showing a candidate, incentivized ad to user A.

If the system determines that the answer is no to the question in block 810, the system 100, at block 820, delivers to the user an ad without incentives, e.g., a normal advertisement. If the system determines that the answer is yes to the question in block 810, the system, at block 830, delivers to user A an incentivized ad with sharing and conversion functions initiated. The incentivized or non-incentivized ad delivered to user A may be targeted for instance by matching a category or product type with which the ad is classified to a similarly-classified ad referred by or to user A in the past.

At block 840, the system 100 records user A's activity and interaction with the delivered ad, including conversion and referral activity and the like. At block 850, the system 100 may determine whether user A has shared the ad with others, such as friends or connected persons in the social network of user A. If the answer is yes, then the system 100, at block 860, provides user A with the economic incentives promised, such as an additional discount, credits, points, or currency or the like. If the answer is no, then the system, at block 870, determines whether user A converted the ad deal. If user A did convert, then the system 100, at block 880, provides user B with the economic incentives promised where user A's visit is through a referral from user B.

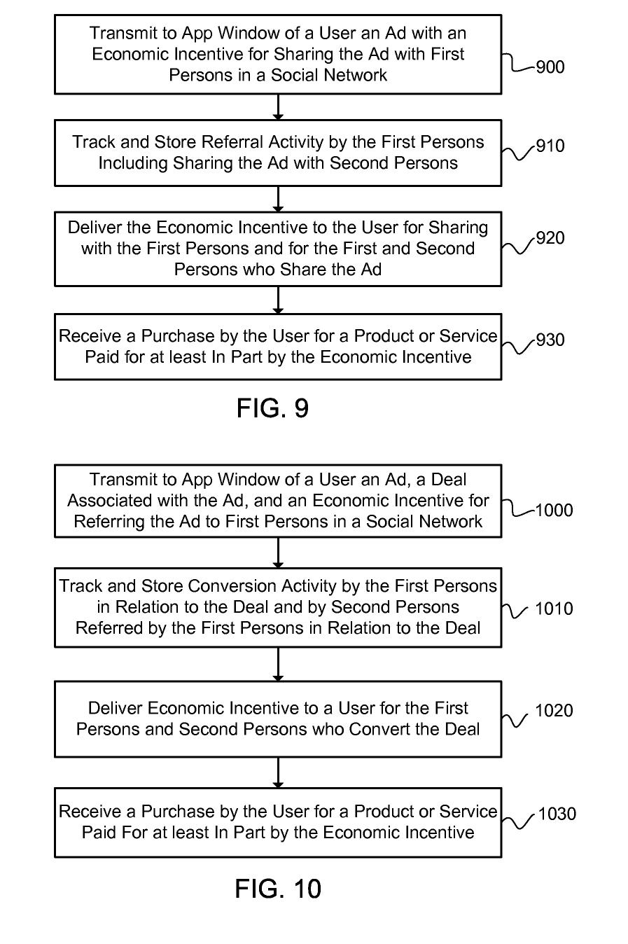

FIG. 9 is a flow chart of a method for incentivizing sharing of advertisements (“ads”) from social network users to connected persons in their respective social networks. At block 900, the system 100 transmits to a user, for display in an application window of a communication device of the user, an advertisement with an economic incentive for sharing the advertisement with first persons in a social network of the user. At block 910, the system 100 tracks and stores in data storage referral activity by the first persons in the social network of the user in relation to the advertisement, the referral activity including the first persons sharing the advertisement with second persons. At block 920, the system 100 delivers the economic incentive to the user for sharing with the first persons and for the first and second persons who share the advertisement. At block 930, the system 100 may receive a purchase by the user for a product or service paid for at least in part by the economic incentive received by the user. The economic incentive may include credits, points, or virtual currency useable for making purchases from an advertiser of the ad or from the system 100 generally. The system 100 may also limit the availability to share the ad to a predetermined time period of an advertising campaign.

FIG. 10 is a flow chart of a method for incentivizing sharing of ads and associated deals from social network users to connected persons in their respective social networks. At block 1000, the system 100 transmits to a user, for display in an application window of a communication device of the user, an advertisement, a deal associated with the advertisement, and an economic incentive for referring the advertisement to first persons in a social network of the user. The ad may be transmitted via email or to a social networking website frequented by the user. At block 1010, the system 100 tracks and stores in data storage conversion activity by the first persons in the social network of the user in relation to the deal and by second persons referred by the first persons in relation to the deal, the conversion activity including a determined action taken with reference to the deal. At block 1020, the system 100 delivers the economic incentive to the user for each first person and each second person who converted the deal up to a limit of accruable economic incentive. The determined action may include but not be limited to: purchasing an advertised product; signing up for an advertised service; or joining a group related to an advertiser of the advertisement. At block 1030, the system 100 may further receive a purchase by the user for a product or service paid for at least in part by the economic incentive received by the user.

As discussed earlier, the tracking and storing of referral and conversion activity may also take place with respect to third persons referred by the second persons and by subsequently-referred persons down a chain of referrals. The economic incentives may accumulate to the user for further referrals and conversions beyond the second level of separation, e.g., to the third and subsequently-referred persons or friends. The economic incentives, however, may be limited to diminishing amounts or percentages to hedge against abuse. The number of initial connected persons with whom a user shares may also be limited to similarly protect against abuse.

Some of the benefits of the present system include but are not limited to that fact that users are more incentivized to share and encourage their friends or connected persons to both share and convert when the user gets compensated for such referral and conversion activity. Advertisers get additional ad-views because of the sharing and ads are directed in a more targeted fashion by users to friends or persons with the most likely intent to convert or at least to pass the ad on to their friends. Also, publishers get better targeting for the same reasons, which means the publishers will get higher revenue for delivering ads to their web pages or search engines.

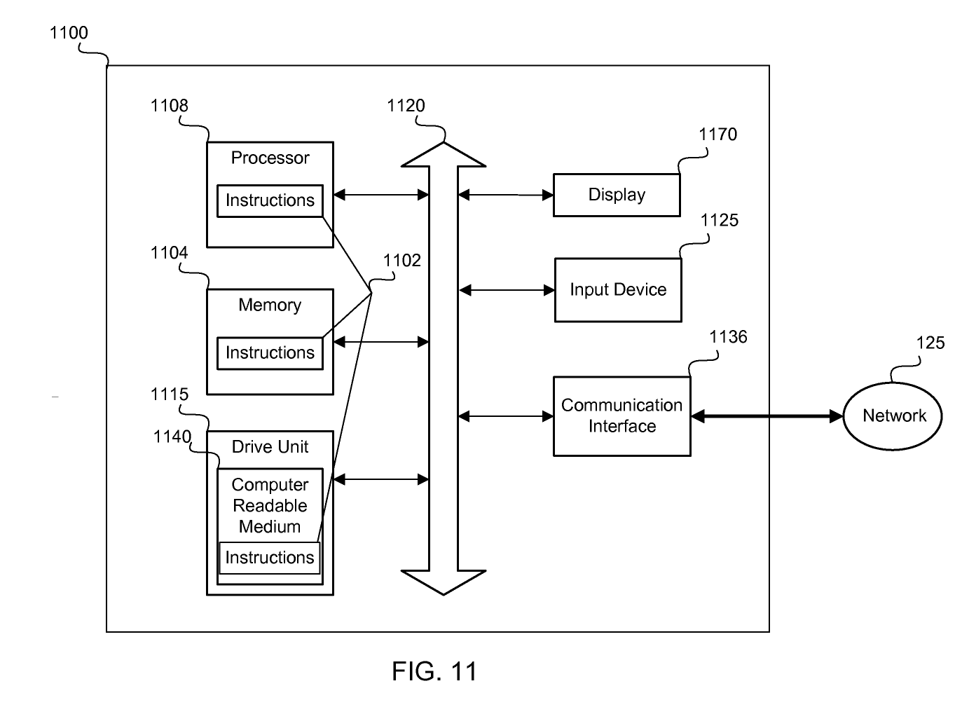

FIG. 11 illustrates a general computer system 1100, which may represent the web server 104, the search engine 108, the applications server 116, the social networking server 120, the user profile server 124, the incentives server 130, the ad server 144, or any other computing devices referenced herein or that may be executed by the system 100, such as, for instance, the communications devices of the advertisers 150 and the user communication devices 160, 162, whether fixed or mobile. The computer system 1100 may include an ordered listing of a set of instructions 1102 that may be executed to cause the computer system 1100 to perform any one or more of the methods or computer-based functions disclosed herein. The computer system 1100 may operate as a stand-alone device or may be connected, e.g., using the network 125, to other computer systems or peripheral devices.

In a networked deployment, the computer system 1100 may operate in the capacity of a server or as a client-user computer in a server-client user network environment, or as a peer computer system in a peer-to-peer (or distributed) network environment. The computer system 1100 may also be implemented as or incorporated into various devices, such as a personal computer or a mobile computing device capable of executing a set of instructions 1102 that specify actions to be taken by that machine, including and not limited to, accessing the Internet or Web through any form of browser. Further, each of the systems described may include any collection of sub-systems that individually or jointly execute a set, or multiple sets, of instructions to perform one or more computer functions.

The computer system 1100 may include a memory 1104 on a bus 1120 for communicating information. Code operable to cause the computer system to perform any of the acts or operations described herein may be stored in the memory 1104. The memory 1104 may be a random-access memory, read-only memory, programmable memory, hard disk drive or any other type of volatile or non-volatile memory or storage device.

The computer system 1100 may include a processor 1108, such as a central processing unit (CPU) and/or a graphics processing unit (GPU). The processor 1108 may include one or more general processors, digital signal processors, application specific integrated circuits, field programmable gate arrays, digital circuits, optical circuits, analog circuits, combinations thereof, or other now known or later-developed devices for analyzing and processing data. The processor 808 may implement the set of instructions 1102 or other software program, such as manually-programmed or computer-generated code for implementing logical functions. The logical function or any system element described may, among other functions, process and/or convert an analog data source such as an analog electrical, audio, or video signal, or a combination thereof, to a digital data source for audio-visual purposes or other digital processing purposes such as for compatibility for computer processing.

The computer system 1100 may also include a disk or optical drive unit 1115. The disk drive unit 1115 may include a computer-readable medium 1140 in which one or more sets of instructions 1102, e.g., software, can be embedded. Further, the instructions 1102 may perform one or more of the operations as described herein. The instructions 1102 may reside completely, or at least partially, within the memory 1104 and/or within the processor 1108 during execution by the computer system 1100. Accordingly, the databases 128, 140, and 148 described above in FIG. 1 may be stored in the memory 1104 and/or the disk unit 1115.

The memory 1104 and the processor 1108 also may include computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 1100 may include an input device 1125, such as a keyboard or mouse, configured for a user to interact with any of the components of system 1100. It may further include a display 1170, such as a liquid crystal display (LCD), a cathode ray tube (CRT), or any other display suitable for conveying information. The display 1170 may act as an interface for the user to see the functioning of the processor 1108, or specifically as an interface with the software stored in the memory 1104 or the drive unit 1115.

The computer system 1100 may include a communication interface 1136 that enables communications via the communications network 125. The network 125 may include wired networks, wireless networks, or combinations thereof. The communication interface 1136 network may enable communications via any number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein. Such a programmed computer may be considered a special-purpose computer.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As discussed above, the system serves advertisements and interfaces that convey additional information related to the advertisement. For example, the system generates browser code operable by a browser to cause the browser to display a web page of information that includes an advertisement. The advertisement may include a graphical indicator that indicates that the advertisement is associated with an interface that conveys additional information associated with the advertisement. The browser code is operable to cause the browser to detect a selection of the graphical indicator, and display the interface along with the information displayed on the web page in response to the selection of the graphical indicator. The advertisement and the additional information conveyed via the interface are submitted by an advertiser during an advertisement submission time.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

1. A method for incentivizing sharing advertisements with others, the method executable by a computer coupled with a processor and data storage, the method comprising:
transmitting to a user, by the computer for display in an application window of a communication device of the user, an advertisement with an economic incentive for sharing the advertisement with first persons in a social network of the user;
tracking and storing in the data storage, by the computer, referral activity by the first persons in the social network of the user in relation to the advertisement, the referral activity comprising the first persons sharing the advertisement with second persons; and
delivering, by the computer, the economic incentive to the user for sharing the advertisement and for the first and second persons who share the advertisement.

2. The method of claim 1, where the economic incentive for sharing includes credits or points that are useable for making purchases, the method further comprising:
limiting the availability to share the advertisement to a predetermined time period of an advertising campaign; and
targeting the user with the advertisement based on the user having been referred another ad in the past related to a category or product type with which the advertisement is classified.

3. The method of claim 1, where transmitting the advertisement is executed through email or through a social networking website, the method further comprising:
receiving a purchase by the user for a product or service paid for at least in part by the economic incentive received by the user.

4. The method of claim 1, further comprising:
awarding the user an additional economic incentive for converting a deal associated with the advertisement when sharing with the first persons, the additional economic incentive comprising a percentage off the deal and an additional, incremental percentage off the deal determined based on an expected value of downstream conversion of the advertisement based on a number of first persons with whom the user shares the deal.

5. The method of claim 1, further comprising:
awarding an additional economic incentive to the user for converting a deal associated with the advertisement and further economic incentives for the first and second persons that convert the deal, the additional economic incentive comprising a first percentage off the deal;
tracking and storing in the data storage conversion activity by the first and second persons in the social network in relation to the deal, the conversion activity comprising purchasing an advertised product, signing up for an advertised service, or joining a group related to an advertiser of the advertisement; and
when the user converts the deal, delivering the further economic incentives to the user for each first person and each second person who convert the deal.

6. The method of claim 5, where the further economic incentive for conversions made by each first person comprises an additional second percentage off the deal and for conversions made by each second person comprises an additional third percentage off the deal, where the third percentage is lower than the second percentage.

7. The method of claim 6, where the economic incentive for sharing includes points or credits useable toward purchases, the further economic incentives also include the points or credits, and the first and second persons are also considered users among a plurality of users that receive the advertisement and associated deal, the method further comprising:
transmitting a status page for display in the application window of the communication device of the user, the status page including one or more of:
a number of the plurality of users that have shared the advertisement and deal;
an amount of credits or points accrued by the user for sharing the advertisement and for the first and second persons that convert the deal;
an amount of saved currency in converting the deal by the user based on the first, second, and third additional percentages off;
an amount of currency saved by users in the social network that also converted the deal based on the sharing of the advertisement; and
a leader board of users ranked by amount of currency saved to the users with whom the advertisement and deal were shared by the ranked users.

8. The method of claim 7, where the further economic incentive for conversions made by each first person comprises a first number of credits and for conversions made by each second person comprises a second number of credits, where the second number of credits are fewer than the first number of credits, and the credits are useable for making purchases.

9. The method of claim 5, further comprising:
delivering economic incentives to the user for sharing with and for conversions made by at least some of a plurality of subsequently-referred persons, the subsequently-referred persons being referred by the second or other downstream persons; and
limiting possibilities of fraud by one or more of:
limiting a number of first persons with whom the user is allowed to share the advertisement;
limiting a total amount of economic incentive accruable to the user for sharing the deal; and
increasingly diminishing an amount of economic incentive to the user for sharing and conversions made by the second and subsequently-referred persons.

10. A method for incentivizing referrals of advertisements to others, the method executable by a computer coupled with a processor and data storage, the method comprising:
transmitting to a user, by the computer for display in an application window of a communication device of the user, an advertisement, a deal associated with the advertisement, and an economic incentive for referring the advertisement to first persons in a social network of the user;
tracking and storing in the data storage, by the computer, conversion activity by the first persons in the social network of the user in relation to the deal and by second persons referred by the first persons in relation to the deal, the conversion activity comprising a determined action taken with reference to the deal; and
delivering, by the computer, the economic incentive to the user for the first and second persons who convert the deal.

11. The method of claim 10, where the user is required to purchase the deal to obtain the economic incentive, and the determined action comprises purchasing an advertised product, signing up for an advertised service, or joining a group related to an advertiser of the advertisement.

12. The method of claim 10, where transmitting the advertisement is executed through email or through a social networking website, the method further comprising:
receiving a purchase by the user for a product or service paid for at least in part by the economic incentive received by the user.

13. The method of claim 10, further comprising:
awarding an additional economic incentive of a first percentage off the deal to the user for converting the deal, where the economic incentive for each first person that converts the deal comprises a second percentage off and for each second person that converts the deal comprises a third percentage off up to a limit of accruable economic incentive, where the third percentage is lower than the second percentage.

14. The method of claim 13, where the first and second persons are also considered users among a plurality of users of the social network that receive the advertisement and associated deal, the method further comprising:
transmitting a status page for display in the application window of the communication device of the user, the status page including one or more of:
an amount of saved currency in converting the deal by the user based on the first, second, and third additional percentages off;
an amount of currency saved by users in the social network that also converted the deal based on referring the advertisement; and
a leader board of users ranked by amount of currency saved to the users to whom the advertisement and deal were referred by the ranked users.

15. The method of claim 10, further comprising:
awarding an additional economic incentive of a percentage off the deal to the user for converting the deal, where the economic incentive for each first person that converts the deal comprises a first number of credits and for each second person that converts the deal comprises a second number of credits up to a limit of accruable economic incentive, where the second number of credits are fewer than the first number of credits, and the credits are useable for making purchases.

16. A system for incentivizing sharing advertisements and associated deals with others, comprising:
a server including a memory and a processor, the processor configured to execute an economic incentivizer and an incentives tracker, the economic incentivizer to transmit to a user, for display in an application window of a communication device of the user, an advertisement with an economic incentive for sharing the advertisement with first persons in a social network of the user, the incentives tracker to track and store in the memory referral activity by the first persons in the social network of the user in relation to the advertisement, the referral activity comprising the first persons sharing the advertisement with second persons, where the server delivers the economic incentive to the user for sharing with the first persons and for the first and second persons who share the advertisement.

17. The system of claim 16, further comprising the server coupled with a social networking server, the social networking server to transmit a social networking website to the application window of the user through which the advertisement is transmitted.

18. The system of claim 16, further comprising the server coupled with an email server, the email server to transmit an email application or an email to the display of the communication device, the email application or email including the advertisement.

19. The system of claim 16, where the economic incentives comprise one or more of points, credits, and virtual currency, further comprising the server to receive a purchase by the user for a product or service paid for at least in part by the economic incentive received by the user.

20. The method of claim 16, further comprising the server to award the user an additional economic incentive for converting a deal associated with the advertisement when sharing with the first persons, the additional economic incentive comprising a percentage off the deal and an additional, incremental percentage off the deal determined based on an expected value of downstream conversion of the advertisement based on a number of first persons with whom the user shares the deal.

21. The system of claim 16, further comprising the server to award an additional economic incentive to the user for converting a deal associated with the advertisement and further economic incentives for the first and second persons that convert the deal, the additional economic incentive comprising a first percentage off the deal; the incentives tracker to track and store in the memory conversion activity by the first and second persons in the social network in relation to the deal, the conversion activity comprising purchasing an advertised product, signing up for an advertised service, or joining a group related to an advertiser of the advertisement; and when the user converts the deal, the server to deliver the further economic incentives to the user for each first person and each second person who convert the deal up to a limit of accruable economic incentive.

22. The system of claim 21, where the further economic incentive for conversions made by each first person comprises an additional second percentage off the deal and for conversions made by each second person comprises an additional third percentage off the deal, where the third percentage is lower than the second percentage.

23. The system of claim 21, where the further economic incentive for conversions made by each first person comprises a first number of credits and for conversions made by each second person comprises a second number of credits, where the second number of credits are fewer than the first number of credits, and the credits are useable for making purchases.
